(19) United States
(12) Patent Application Publication
(10) Pub. No.: US 2026/0285501 A1
(43) Pub. Date: Sep. 24, 2026

(54) AIR HOSE CONNECTOR

(71) Applicant: LLINOIS TOOL WORKS INC., GLENVIEW, IL (US)

(72) Inventors: Bo Vork NIELSEN, Fåborg (DK); Lars SCHRØDER, Assens (DK)

(73) Assignee: ILLINOIS TOOL WORKS, GLENVIEW, IL (US)

(21) Appl. No.: 19/168,914

(22) PCT Filed: Apr. 5, 2024
(86) PCT No.: PCT/US2024/023301

§ 371 Date: Sep. 25, 2025

(30) Foreign Application Priority Data
Apr. 12, 2023 (GB) 2305318.4

(51) Int. Cl. B64F 1/36; F16L 37/127

(52) U.S. Cl. CPC B64F 1/362; F16L 37/127

(57) ABSTRACT

An air hose connector (10) for an air hose. The air hose connector has a first end (12) that is configured for direct or indirect connection to a pre-conditioned air hose, a second open end (14) that is configured for connection to an aircraft, and a handle (30) that is operably connected to the air hose connector. The handle includes a locking member (34), which is adjacent to said first end of said connector, and a grip portion (32), which is adjacent to said second end of said connector. The handle is configured to move the locking member between a first, locked, configuration and a second, unlocked, configuration. The handle comprises a remote control unit (36) that is configured to remotely control a function of a component of an air hose system.

### TECHNICAL FIELD OF INVENTION

The invention relates to an air hose connector. In particular, the invention relates to an air hose connector for connecting an air hose to an aircraft, so that air, for example pre-conditioned air, can be delivered to the aircraft.

### BACKGROUND

Pre-conditioned air systems are used to bring cooled or heated air into a parked aircraft. Air is supplied from a pre-conditioned air unit to cabins of the aircraft via air hoses, which are referred to as pre-conditioned air hoses, when the aircraft is grounded and an auxiliary power unit is not operational. Such air hoses are often around 18 metres in length and can weigh around 30 kilograms. The pre-conditioned air unit is typically mounted to a passenger boarding bridge at an airport.

There are two types of pre-conditioned air hoses, each of which requires a different storage system at a passenger boarding bridge.

The first type, known as flat hoses, do not have wire reinforcement and so may be flattened, when deflated, and rolled for storage. This is advantageous as a reel of flattened and rolled hose is relatively small, as compared to other airport equipment. The reel is compact and can be stored easily on the bridge, which is busy with other equipment. However, disadvantageously, the entire hose must be unrolled from the reel in order to get air through the hose.

The second type, known as spiral hoses, have a wire reinforcement. The spiral wire located in or around the circumference of the hose allows the hose to be axially compressed for storage. Spiral hoses are stored in pre-conditioned air hose retrievers. As passenger boarding bridges are busy with equipment, it can be difficult to get sufficient space for a hose retriever. In contrast to flat hoses, however, spiral hoses do not need to be fully extended in order for air to flow through the hose. This means that only the length of hose necessary to reach the aircraft from the storage position needs to be extracted from the hose retriever.

Regardless of which type of pre-conditioned air hose is used, an air hose connector is provided to enable the attachment of the air hose to the aircraft.

An operator typically pulls the air hose to the aircraft using the air hose connector and uses a locking mechanism on the air hose connector to lock the air hose in position on the aircraft. Given the length and weight of pre-conditioned air hoses, this can require significant effort by the operator.

It is therefore known to provide air hose reel operation mechanisms, for example drive mechanisms, that reduce the effort required by an operator to pull the air hose the required distance to the aircraft.

Known examples of such air hose reel operation mechanisms include remote controls by which operators can control movement of an air hose from and to its storage system. Examples of such remote controls include batteries and numerous other components and so are bulky, which makes them heavy, cumbersome and inefficient for operators to use. These remote controls are also separate components, which makes it challenging for an operator to use them whilst moving an air hose and increases the risk the remote controls being lost and/or damaged and/or not returned for charging when not in use.

It would therefore be advantageous to provide a pre-conditioned air hose connector which overcomes the limitations of known air hose connectors and/or which is more convenient for an operator to use.

### SUMMARY

According to a first aspect of the present invention, there is provided an air hose connector for an air hose, for example a pre-conditioned air hose connector for a pre-conditioned air hose.

The air hose connector may comprise a first end that is configured for direct or indirect connection to a pre-conditioned air hose. The first end of the air hose connector may be, for example, configured for direct connection to an end of a pre-conditioned air hose. Alternatively, the first end of the air hose connector may be configured for connection to another component, for example an adapter or a swivel, via which the air hose connector is indirectly connected to a pre-conditioned air hose. The air hose connector may also comprise a second end that that is configured for connection to an aircraft.

A handle may be operably connected to the air hose connector. The handle may comprise a grip portion adjacent to said first end of said connector and a locking member adjacent to said second end of said connector.

Said handle may be configured to move the locking member between a first, locked, configuration and a second, unlocked, configuration.

The handle may comprise a controller, for example a remote control unit, that is configured to remotely control a function, for example one or more functions, of a component, for example one or more components of an air hose system. The component or components may include an air hose storage system and/or an air supply system. In other words, the air hose system may comprise an air hose storage system and/or an air supply system. The remote control unit may, for example, control the movement of an air hose into and/or out of an air hose storage system, for example a reel or a retriever and/or to start and/or stop of the supply of air through the or an air hose from or by an air supply system.

According to an aspect of the invention there is provided an air hose connector for an air hose, the air hose connector comprising: a first end that is configured for direct or indirect connection to a pre-conditioned air hose, a second end that that is configured for connection to an aircraft, and a handle operably connected to the air hose connector; wherein the handle comprises: a grip portion adjacent to said first end of said air hose connector, and a locking member adjacent to said first end of said air hose connector; wherein said handle is configured to move the locking member between a first, locked, configuration and a second, unlocked, configuration; and wherein the handle comprises a remote control unit that is configured to control a function, for example one or more functions, of a component, for example one or more components, of an air hose system.

Advantageously, the handle serves the dual purpose of actuating the locking mechanism, to secure and/or release, the air hose connector and its air hose to and/or from an aircraft, as well as controlling the deployment and/or stowing of the air hose from and/or to an air hose storage system, for example an air hose retriever. The air hose connector is therefore ergonomic and more convenient for an operator to use.

The remote control unit may form part of the handle, for example part of the grip portion of the handle. The remote control unit may be a hollow body within which components of the remote control are accommodated. Advantageously, this enables the provision of an ergonomic handle that is lightweight and in which components of the remote control are protected from the external environment.

Each of the first end and the second end of the air hose connector may be open such that the air hose connector is generally tubular and provides a conduit for the passage of air therethrough.

The grip portion may include said remote control unit. The remote control unit may be, for example, integrated into the grip portion.

In this way, the remote control unit can readily be accessed and used by an operator whilst the air hose is being moved toward an aircraft.

The remote control unit may include a button, for example a pushbutton. The button may be wireless. The provision of a wireless button advantageously enables communication between the remote control unit on the handle of the air hose connector and a receiver on, for example, a storage system for the air hose, e.g. an air hose retriever, or an air hose storage system on a passenger boarding bridge, in order to control the deployment of the air hose from the air hose storage system or the return of the air hose to the air hose storage system.

The button may include a transmitter. The transmitter in the button may communicate, for example with a receiver on a storage system for the air hose, e.g. an air hose retriever, or an air hose storage system on a passenger boarding bridge in order to control the deployment of the air hose from the air hose storage system or the return of the air hose to the air hose storage system.

Additionally or alternatively, the button may be battery-less. Advantageously, this reduces the size and complexity of the button, which facilitates the incorporation of the button into the handle of the air hose connector and the accessibility of the button (and therefore the remote control unit) to an operator.

The button may include an energy converter, for example an electric generator. The button may, for example convert the mechanical energy that is produced by pressing the button into electrical energy that is used to power the remote control unit. The provision of an energy converter improves the reliability of the remote control unit.

The handle may be pivotably connected to the air hose connector. The handle may be, for example, pivotably connected to an outer wall of said air hose connector.

The air hose connector may comprise an outer housing within which a portion of the handle is accommodated. The grip portion may extend from a recess at a first end of said outer housing. The locking member may extend through a recess at a second end of said outer housing. The accommodation of a portion of the handle within the outer housing advantageously protects the pivotable connection of the handle from water, dust, dirt or other impurities which might affect operation of the air hose connector.

The component or components of the air hose system may include an air hose storage system and/or an air supply system. In other words, the air hose system may comprise an air hose storage system and/or an air supply system.

The remote control unit may be configured to control the movement of an air hose into and/or out of an air hose storage system. Additionally or alternatively, the remote control unit may be configured to control an air supply system. The remote control unit may be, for example, configured to control the supply of air to an air hose from or by an air supply system. The remote control unit may be, for example, configured to start and/or stop of the supply of air through the or an air hose from or by an air supply system.

The handle may be a first handle. The air hose connector may include a second handle operably connected to the air hose connector. The second handle may comprise a grip portion adjacent to said first end of said air hose connector, and a locking member adjacent to said first end of said air hose connector; wherein said second handle is configured to move the locking member between a first, locked, configuration and a second, unlocked, configuration. The second handle may comprise a remote control unit that is configured to control the movement of an air hose into and out of an air hose storage system.

Advantageously, the second handle may also serve the dual purpose of actuating of the locking mechanism, to secure and/or release the air hose connector and its air hose to and/or from an aircraft, as well as controlling the deployment and/or stowing of the air hose from and/or to its air hose storage system.

The grip portion of the second handle may include said remote control unit. The remote control unit may be, for example, integrated into the grip portion of the second handle.

In this way, the remote control unit can readily be accessed and used by an operator whilst the air hose is being moved toward an aircraft.

The remote control unit may form part of the second handle, for example part of the grip portion of the second handle. The remote control unit may be a hollow body within which components of the remote control are accommodated. Advantageously, this enables the provision of an ergonomic handle that is lightweight and in which components of the remote control are protected from the external environment.

The remote control unit of the second handle may include a button, for example a pushbutton. The button may be wireless. The provision of a wireless button advantageously enables communication between the remote control unit on the handle of the air hose connector and a receiver on, for example, a storage system for the air hose, e.g. an air hose retriever, or an air hose storage system on the passenger boarding bridge in order to control the deployment of the air hose from the air hose storage system and/or the return of the air hose to the air hose storage system.

The button of the second handle may include a transmitter. The transmitter in the button may communicate, for example with a receiver on a storage system for the air hose, e.g. an air hose retriever, or an air hose storage system on the passenger boarding bridge in order to control the deployment of the air hose from the air hose storage system and/or the return of the air hose to the air hose storage system.

Additionally or alternatively, the button may be battery-less. Advantageously, this reduces the size and complexity of the button, which facilitates the incorporation of the button into the handle of the air hose connector and the accessibility of the button (and therefore the remote control unit) to an operator.

The button of the second handle may include an energy converter, for example an electric generator. The button may, for example convert the mechanical energy that is produced by pressing the button into electrical energy that is used to power the remote control unit. The provision of an energy converter, for example an electric generator, improves the reliability of the remote control unit.

The second handle may be pivotably connected to the air hose connector. The second handle may be, for example, pivotably connected to an outer wall of said air hose connector.

The air hose connector may comprise a second outer housing within which a portion of the second handle is accommodated. The grip portion may extend from a recess at a first end of said second outer housing. The locking member may extend through a recess at a second end of said second outer housing. The accommodation of a portion of the second handle within the second outer housing advantageously protects the pivotable connection of the second handle from water, dust, dirt or other impurities which might affect operation of the air hose connector.

The remote control unit of the second handle may be configured to control the movement of an air hose into and/or out of an air hose storage system. Additionally or alternatively, the remote control unit of the second handle may be configured to control an air supply system. The remote control unit of the second handle may be, for example, configured to control the supply of air to an air hose from or by an air supply system. The remote control unit of the second handle may be, for example, configured to start and/or stop of the supply of air through the or an air hose from or by an air supply system.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF DRAWINGS

Example embodiment(s) of the invention are illustrated in the accompanying drawings, in which:

FIG. 1 illustrates a pre-conditioned air hose to which an air hose connector according to an embodiment of the invention is attached;

FIG. 2 is a perspective view of an air hose connector according to an embodiment of the invention;

FIG. 3 is an alternative perspective view of the air hose connector of FIG. 2;

FIG. 4 is a perspective view of an air hose connector according to an alternative embodiment of the invention; and

FIG. 5 is a cross section view of the air hose connector of FIG. 4.

### DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Like reference numerals are used to depict like features throughout, i.e. identical reference numerals are used for components identical in different embodiments of the present invention.

The illustrative embodiment relates to an air hose connector, which may be a pre-conditioned air hose connector.

The air hose connector is intended for use with a pre-conditioned air hose for an aeroplane. However, the air hose connector can be used with a pre-conditioned air hose for any suitable aircraft, e.g. a helicopter. The air hose connector may form part of an air hose system, for example an air hose system including an air hose, an air hose connector and one or more additional components, for example an air hose storage system, an air supply system and a swivel.

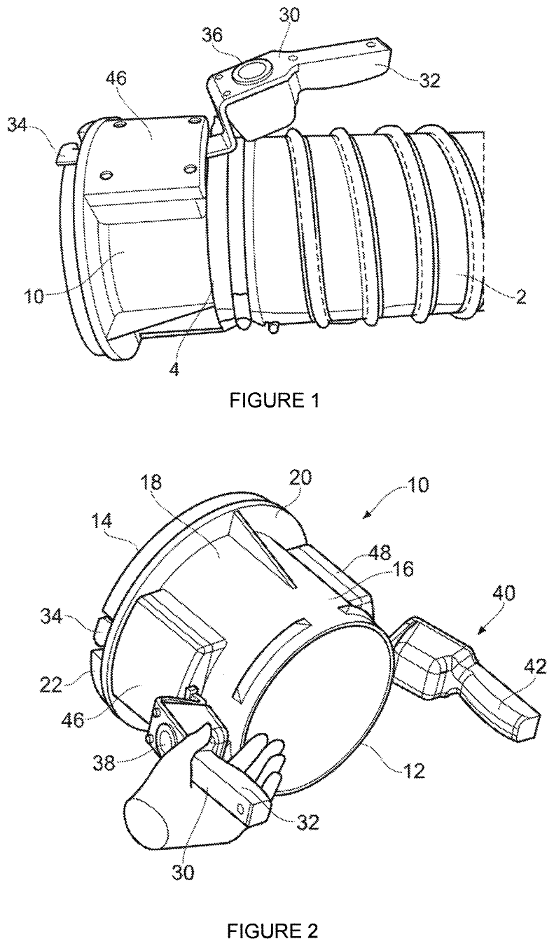

Referring to FIG. 1 there is shown an air hose 2 having a first end 4 at which an air hose connector 10 is attached.

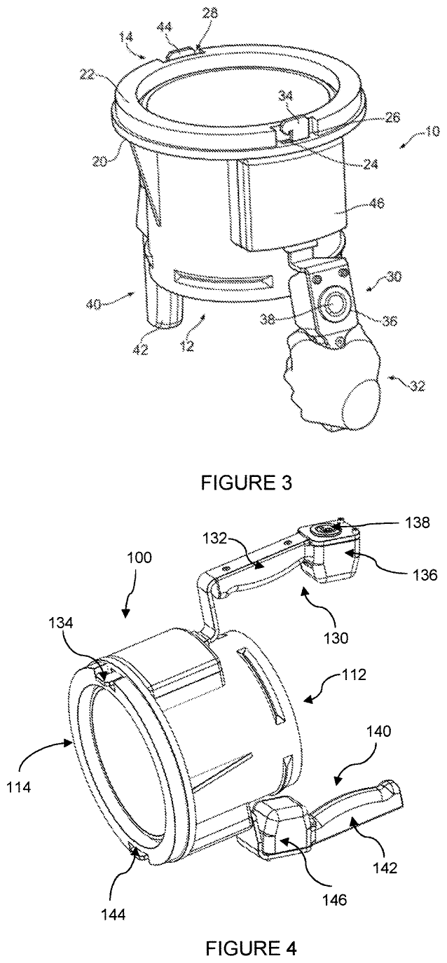

The air hose connector 10 will be described with particular reference to FIGS. 2 and 3.

The air hose connector 10 has a first end 12 that is configured for direct connection to a pre-conditioned air hose 2 (as shown in FIG. 1). In other embodiments of the invention, the air hose connector 10 may be configured for indirect connection to a pre-conditioned air hose 2. The air hose connector 10 may be, for example, configured for attachment to a pre-conditioned air hose via another component, e.g. a swivel.

The air hose connector 10 has a second end 14 that that is configured for connection to an aircraft (not shown). Each of the first end 12 and the second end 14 is open such that the air hose connector 10 has a generally tubular body 16 having an outer wall 18.

A flange 20 is provided at the second end 14 of the air hose connector 10. The flange 20 extends around the outer circumference of the second end 14 of the air hose connector 10.

With particular reference to FIG. 3, the flange 20 includes a first aperture 24 which extends between a first surface of the flange 20, which faces the first end 12 of the air hose connector 10, and a second surface of the flange 20, which faces the second end 14 of the air hose connector 10. The flange 20 includes a second aperture (not shown) which also extends between the first surface and the second surface of the flange 20. The second aperture is positioned on a portion of the flange 20 which is on an opposing side of the air hose connector 10 to the first aperture 24.

A seal 22 is provided on the second surface of the flange 20 and extends around the surface of the flange 20 at the second end 14 of the air hose connector 10. The seal 22 includes a first opening 26, which is adjacent to the first aperture 24 of the flange 20, and a second opening 28, which is adjacent to the second aperture of the flange 20.

The air hose connector 10 includes a handle 30 which is operably connected to the air hose connector 10. The handle 30 includes a grip portion 32, which is adjacent to the first end 12 of the air hose connector 10, and a locking member 34, which is adjacent to the second end 14 of the air hose connector 10. As will be described in more detail below, the handle 30 is configured to move the locking member 34 between a first, locked, configuration, in which the air hose connector 10 may be secured to an aircraft, and a second, unlocked, configuration, in which the air hose connector may be released from the aircraft.

The handle 30 also includes a remote control unit 36. The remote control unit 36 is a hollow body which forms part of the handle 30 and is configured to accommodate components of the remote control. In other words, the remote control is positioned within the remote control unit 36 of the handle 30. As will also be described in more detail below, the remote control unit 36 is configured to control the movement of an air hose 2 into and out of an air hose storage system (not shown), for example an air hose retriever or an air hose storage system on a passenger bridge. The accommodation of components of the remote control within the remote control unit 36 of the handle 30 advantageously protects the components of the remote control from water, dust, dirt or other impurities which might affect operation of the air hose connector 10.

The grip portion 32 of the handle 30 includes the remote control unit 36. In the illustrated embodiment, the remote control unit 36 is integrated into the grip portion 32 of the handle 30. In the illustrated embodiment, the remote control unit 36 includes a button 38 in the form of a pushbutton. The button 38 of the remote control unit 36 is provided on an outer surface of the remote control unit 36. The button 38 may protrude from the outer surface of the remote control unit 36. Alternatively, the button 38 may have an outer surface that forms part of the outer surface of the remote control unit 36. As will be described in more detail below, the button 38 is wireless and includes a transmitter (not shown).

In examples of the invention, the button 38 may be battery-less. The button 38 may, for example, include an energy converter (not shown), such as an electric generator.

In the illustrated embodiment, the air hose connector 10 includes a second handle 40. The second handle 40 is provided on an opposing side of the air hose connector 10. Like the handle 30, the second handle 40 is operably connected to the air hose connector 10. The second handle 40 includes a grip portion 42, which is adjacent to the first end 12 of the air hose connector 10, and a locking member 44, which is adjacent to the second end 14 of the air hose connector 10. As will be described in more detail below, the second handle 40 is configured to move the locking member 44 between a first, locked, configuration, in which the air hose connector 10 may be secured to an aircraft, and a second, unlocked, configuration, in which the air hose connector may be released from the aircraft.

The second handle 40 may also include a remote control unit (not shown) as described in relation to the remote control unit 36 of the handle 30. The remote control unit of the second handle 40 is a hollow body which forms part of the second handle 40 and is configured to accommodate components of the remote control. In other words, the remote control is positioned within the remote control unit of the handle 40. It will be understood that, in embodiments of the invention, a remote control unit 36 may be provided as part of the handle 30, or as part of the second handle 40, or remote control units 36 may form part of each of the handle 30 and the second handle 40. The accommodation of components of the remote control within the remote control unit 36 of the handle 30, 40 advantageously protects the components of the remote control from water, dust, dirt or other impurities which might affect operation of the air hose connector 10.

The grip portion 42 of the handle 40 includes the remote control unit. In the illustrated embodiment, the remote control unit is integrated into the grip portion 42 of the handle 40. In the illustrated embodiment, the remote control unit includes a button in the form of a pushbutton. The button of the remote control unit is provided on an outer surface of the remote control unit. The button may protrude from the outer surface of the remote control unit. Alternatively, the button may have an outer surface that forms part of the outer surface of the remote control unit. As described in relation to the button 38 of the handle 30, the button of the second handle 40 may be wireless and include a transmitter (not shown).

The air hose connector 10 includes an outer housing 46. The outer housing 46 is mounted on the outer wall 18 of the air hose connector 10 in a position intermediate the grip portion 32 and the locking member 34 of the handle 30. The outer housing 46 has a first end which is adjacent to the grip portion 32 of the handle 30 and a second end which is adjacent to the flange 20 of the air hose connector 10. The outer housing 46 includes a first recess (not shown), which is adjacent to the grip portion 32 and remote control unit 36 of the handle 30, and a second recess (not shown), which is aligned with the first aperture 24 which extends through the flange 20.

With particular reference to FIG. 2, the air hose connector 10 includes a second outer housing 48 which is mounted on the outer wall 18 of the air hose connector 10 in a position intermediate the grip portion 42 and the locking member 44 of the second handle 40. The second outer housing 48 has a first end which is adjacent to the grip portion 42 of the second handle 40 and a second end which is adjacent to the flange 20 of the air hose connector 10. The second outer housing 48 includes a first recess (not shown), which is adjacent to the grip portion 42 (and remote control unit, if provided) of the handle 40, and a second recess (not shown), which is aligned with the second aperture (not shown) which extends through the flange 20.

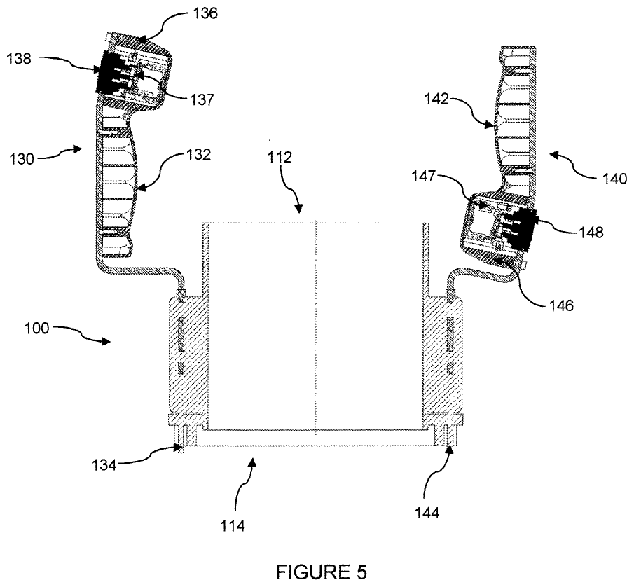

An air hose connector 100 according to an alternative embodiment of the invention will now be described with reference to FIG. 4 and FIG. 5.

The air hose connector 100 includes a handle 130 which is operably connected to the air hose connector 100. The handle 130 includes a grip portion 132, which is adjacent to the first end 112 of the air hose connector 100, and a locking member 134, which is adjacent to the second end 114 of the air hose connector 100. As will be described in more detail below, the handle 130 is configured to move the locking member 134 between a first, locked, configuration, in which the air hose connector 100 may be secured to an aircraft, and a second, unlocked, configuration, in which the air hose connector may be released from the aircraft.

The handle 130 also includes a remote control unit 136. The remote control unit 136 is a hollow body which forms part of the handle 130 and is configured to accommodate components 137 of the remote control. In other words, the remote control is positioned within the remote control unit 136 of the handle 130. As will also be described in more detail below, the remote control unit 136 is configured to control the movement of an air hose 2 into and out of an air hose storage system (not shown), for example an air hose retriever or an air hose storage system on a passenger bridge. The accommodation of components of the remote control within the remote control unit 136 of the handle 130 advantageously protects the components of the remote control from water, dust, dirt or other impurities which might affect operation of the air hose connector 100.

The grip portion 132 of the handle 130 includes the remote control unit 136. In the illustrated embodiment, the remote control unit 136 is integrated into the grip portion 132 of the handle 130. In the illustrated embodiment, the remote control unit 136 includes a button 138 in the form of a pushbutton. The button 138 of the remote control unit 136 is provided on an outer surface of the remote control unit 136. The button 138 may protrude from the outer surface of the remote control unit 136. Alternatively, the button 138 may have an outer surface that forms part of the outer surface of the remote control unit 136. As will be described in more detail below, the button 138 is wireless and includes a transmitter (not shown).

In examples of the invention, the button 138 may be battery-less. The button 138 may, for example, include an energy converter (not shown), such as an electric generator.

In the illustrated embodiment, the air hose connector 100 includes a second handle 140. The second handle 140 is provided on an opposing side of the air hose connector 100. Like the handle 130, the second handle 140 is operably connected to the air hose connector 100. The second handle 140 includes a grip portion 142, which is adjacent to the first end 112 of the air hose connector 100, and a locking member 144, which is adjacent to the second end 114 of the air hose connector 100. As will be described in more detail below, the second handle 140 is configured to move the locking member 144 between a first, locked, configuration, in which the air hose connector 100 may be secured to an aircraft, and a second, unlocked, configuration, in which the air hose connector may be released from the aircraft.

The second handle 140 may also include a remote control unit 146 as described in relation to the remote control unit 136 of the handle 130. The remote control unit 146 of the second handle 140 is a hollow body which forms part of the second handle 140 and is configured to accommodate components 147 of the remote control. In other words, the remote control is positioned within the remote control unit 146 of the handle 140. It will be understood that, in embodiments of the invention, a remote control unit 136, 146 may be provided within one of the handles 130, 140, or a remote control unit 136, 146 may be provided within each of the handle 130 and the second handle 140. The accommodation of components of the remote control within the remote control unit 146 of the second handle 140 advantageously protects the components of the remote control from water, dust, dirt or other impurities which might affect operation of the air hose connector 100.

The grip portion 142 of the handle 140 includes the remote control unit 146. In the illustrated embodiment, the remote control unit 146 is integrated into the grip portion 142 of the handle 140. In the illustrated embodiment, the remote control unit 146 includes a button (not shown) in the form of a pushbutton 148. The button 148 of the remote control unit 146 is provided on an outer surface of the remote control unit 146. The button may protrude from the outer surface of the remote control unit 146. Alternatively, the button may have an outer surface that forms part of the outer surface of the remote control unit 146. As described in relation to the button 138 of the handle 130, the button 148 of the second handle 140 may be wireless and include a transmitter (not shown).

In this embodiment of the invention, the remote control unit 136 of the handle 130 is at one end of the grip portion 132 and the remote control unit 146 of the second handle 140 is at an opposite end of the grip portion 142. It will be appreciated that, in other embodiments of the invention, the remote control units 136, 146 may each the at the same end of the grip portions 132, 142 of the handles 130, 140.

Advantageously, the incorporation of the or each remote control unit 36, 46, 136, 146 into a respective handle 30, 40, 130, 140 enables the provision of an ergonomic air hose controller 10, 100 that is lightweight and easy for an operator to use and for which the components 137, 147 are protected from the external environment.

The air hose connector 10, 100 is assembled as follows.

The seal 22 is mounted to and fixed on the second surface of the flange 20 of the generally tubular body 16 of the air hose connector 10, 100.

The handle 30, 130 is installed on the air hose connector 10, 100 by passing the locking member 34, 134 through the first aperture 24 in the flange 20 and pivotably connecting the handle 30, 130 to the outer wall 18 of the air hose connector 10, 100. The locking member 34, 134 thus extends through the first aperture 24 in the flange 20 and the first opening 26 in the seal 22.

Similarly, the second handle 40, 140 is installed on the air hose connector 10, 100 by passing the locking member 44, 144 through the second aperture in the flange 20 and pivotably connecting the handle 40, 140 to the outer wall 18 of the air hose connector 10, 100. The locking member 44, 144 thus extends through the second aperture in the flange 20 and the second opening 28 in the seal 22.

The outer housing 46 is mounted to the outer wall 18 of the air hose connector 10, 100 such that the locking member 34, 134 extends through the second recess at the second end of the outer housing 46 and the grip portion 32, 132 extends from the first recess at the first end of the outer housing 46. In this way, a portion of the handle 30, 130 (i.e. a portion intermediate the grip portion 32, 132 and the locking member 34, 134) is accommodated within the outer housing 46. This advantageously protects the pivotable connection of the handle 30, 130 to the air hose connector 10, 100 from water, dust, dirt or other impurities which might affect operation of the air hose connector 10, 100.

Similarly, the second outer housing 48 is mounted to the outer wall 18 of the air hose connector 10, 100 such that the locking member 44, 144 extends through the second recess at the second end of the second outer housing 48 and the grip portion 42, 142 extends from the first recess at the first end of the second outer housing 48. In this way, a portion of the second handle 40, 140 (i.e. a portion intermediate the grip portion 42, 142 and the locking member 44, 144) is accommodated within the second outer housing 48. This advantageously protects the pivotable connection of the second handle 40, 140 to the air hose connector 10, 100 from water, dust, dirt or other impurities which might affect operation of the air hose connector 10, 100.

Prior to use, the air hose connector 10, 100 is fastened to an air hose 2.

To deploy the air hose 2, an operator holds one or both of the handles 30, 40, 130, 140 and walks toward an aircraft (to which the air hose is to be attached). By pressing the button 38, 138, the operator is able to control the deployment or release of the air hose 2 from its storage system, which may be an air hose retriever. The energy converter within the button 38, 138 converts the mechanical energy produced by pressing the button into electrical energy. The electrical energy is used to power the transmitter within the button 38, 138. A signal, for example a radio wave signal, is transmitted from the transmitter within the button 38, 138. The signal is received by a receiver which is installed on the air hose storage system and processed by a processor in order to actuate a mechanism by which the air hose 2 is released or deployed from the air hose storage system. Actuation of the release or deployment mechanism may require a single, continuous, press of the button or a series of pulses or presses on the button. The release or deployment mechanism enables an operator to quickly and efficiently guide the air hose 2 to the aircraft without the need to exert a significant amount of energy.

Once at the aircraft, the operator positions the air hose connector 2 in the required position on the aircraft and pivots the handles 30, 40, 130, 140 from the unlocked position (to enable the seal 22 to abut the aircraft wall) to the locked position (in which the locking members 34, 44, 134, 144 engage with locking members on the aircraft to ensure that the air hose connector 10, 100 is locked in position).

Air, for example, pre-conditioned air, may then be supplied to the aircraft via the air hose 2.

When the supply of air is no longer required, the air hose 2 may be released from the aircraft and returned to its storage system.

The operator holds one or both of the handles 30, 40, 130, 140 and pivots them from the locked position (in which the locking members 34, 44, 134, 144 are engaged with locking members on the aircraft) to the unlocked position (so that the air hose connector 10, 100 can be released from the aircraft wall).

The operator can then walk away from the aircraft toward the air hose storage system, whilst holding one or both of the handles 30, 40, 130, 140. By pressing the button 38, 138, the operator is able to control the return of the air hose 2 to its storage system, which may be an air hose retriever. The energy converter within the button 38, 138 converts the mechanical energy produced by pressing the button into electrical energy. The electrical energy is used to power the transmitter within the button 38, 138. A signal, for example a radio wave signal, is transmitted from the transmitter within the button 38, 138. The signal is received by a receiver which is installed on the air hose storage system and processed by a processor in order to actuate a mechanism by which the air hose 2 is returned to the air hose storage system. Actuation of the return mechanism may require a single, continuous, press of the button or a series of pulses or presses on the button. The return mechanism enables an operator to quickly and efficiently return the air hose 2 to its storage system without the need to exert a significant amount of energy.

It will be appreciated that several variations of the aforementioned examples are envisaged, for example a remote control unit 36, 136, 146 may be included on one or both of the handles 30, 40, 130, 140. In other examples of the invention, one remote control unit may be included on one of the handles for controlling the deployment of the air hose from its storage system and a second remote control unit may be included on the other of the handles for controlling the return of the air hose to its storage system.

In the example described, the remote control unit 36, 136, 146 is configured to control the movement of an air hose 2 into and out of an air hose storage system. It will be understood that, in other examples of the invention, the remote control unit 36, 136, 146 may be configured to control other functions. The remote control unit 36, 136, 146 may be, for example, configured to control the supply of air to an aircraft through the air hose 2. In other words, the remote control unit 36 may be configured to start and/or stop the supply of air to an aircraft via the air hose 2.

In the example described, the remote control unit 36, 136, 146 includes a button 38, 138, 148 that is used to control the movement of an air hose 2 into and out of an air hose storage system.

The button 38, 138, 148 may also be used to control other functions, for example starting and/or stopping the supply of air through the air hose 2.

It will be understood that, in examples of the invention, a remote control unit 36, 136, 146 may be provided on the handle 30, 130 or on the second handle 40, 140 or on each of the handle 30, 130 and the second handle 40, 140.

In examples of the invention including a remote control unit 36, 136, 146 on each of the handle 30, 130 and the second handle 40, 140, each of the remote control unit 36, 136, 146 may include a button 38, 138, 148. The button 38, 138 on the handle 30, 130 may perform different functions to the button 148 on the second handle 40, 140.

In examples of the invention, the remote control unit 36, 136, 146 may be configured to control a function of a component of an air hose system, for example one or more functions, of a component, e.g. one or more components of an air hose system. The air hose system may include an air hose, an air hose connector and one or more additional components, for example an air hose storage system, an air supply system, a swivel. The remote control unit 36, 136, 146 may be configured to control a function, for example one or more functions, of an air hose storage system and/or an air supply system.

In one example, the button 38, 138, 148 on the handle 30, 130, 140 may, for example, be used to control the movement of an air hose 2 out of its storage system and/or to start the supply of air through the air hose 2 from an air supply system. The button 38, 148 on the second handle 40, 140 may be used to stop the supply of air through the air hose 2 from an air supply system and/or to control the movement of the air hose 2 back to its storage system.

In another example, the button 38, 138 on the handle 30, 130 may be used to control the movement of an air hose 2 into and/or out of an air hose storage system and the button 38, 148 on the second handle 40, 140 may be used to start and/or stop the supply of air from an air supply system to an aircraft via the air hose 2.

In examples of the invention, the button 38, 138, 148 may be a first button and the remote control unit 36, 136, 146 may include one or more additional buttons. In other words, each of the handle 30, 130 and the second handle 40, 140 may include a remote control 36, 136, 146 that includes one or more buttons 38, 138, 148. One of the buttons, for example the first button, may be used to control the movement of an air hose 2 into and/or out of an air hose storage system and another of the buttons, for example one of the one or more additional buttons, may be used to start and/or stop the supply of air from an air supply system to an aircraft via the air hose 2.

In one example, one of the buttons for example the first button of the remote control unit 36, 136 of the handle 30, 130, may be used to control the movement of an air hose 2 into and/or out of an air hose storage system and/or another of the buttons, for example one of the one or more additional buttons on the remote control unit 36, 136 of the handle 30, 130, may be used to start and/or stop the supply of air from an air supply system to an aircraft via the air hose 2. Similarly, one of the buttons for example the first button of the remote control unit 36, 146 of the second handle 40, 140, may be used to control the movement of an air hose 2 into and/or out of an air hose storage system and/or another of the buttons, for example one of the one or more additional buttons on the remote control unit 36, 146 of the second handle 40, 140, may be used to start and/or stop the supply of air from an air supply system to an aircraft via the air hose 2.

In other words, each handle 30, 40, 130, 140 may include more than one button 38, 138, 148. Each handle 30, 40, 130, 140 may include any number of buttons 38, 138, 148. One button 38, 138, 148, may be used to control the movement of an air hose 2 into and/or out of an air hose storage system and another of the buttons 38, 138, 148 on the same handle 30, 40, 130, 140 may be used to start and/or stop the supply of air from an air supply system to an aircraft via the air hose 2. Different combinations of the buttons 38, 138, 148 may be used to control movement of an air hose 2 into and/or out of an air hose storage system and/or start and/or stop the supply of air from an air supply system through the air hose 2.

In the example described, the button 38, 138, 148 is battery-less. It will be understood that, in other examples of the invention, the button 38, 138, 148 may include a battery, for example a rechargeable battery.

In the example described, the air hose connector 10, 100 is directly connected to an air hose 2. It will be understood that, in other examples of the invention, the air hose connector 10, 100 may be connected to an air hose 2 via one or more additional components, for example a connector or an adapter or a swivel. In other words, the air hose connector 10, 100 may be indirectly connected to an air hose 2.

In the example described above, a remote control unit 36, 136, 146 may be included on one or both of the handles 30, 40, 130, 140. In other examples of the invention the handle 30, 130, the second handle 40, 140 and/or the remote control unit(s) 36, 136, 146 may include one or more feedback or indication units. The feedback or indication unit or units may be configured to provide feedback or an indication of a function of a component of an air hose system to a user. The feedback or indication unit or units may be configured to provide audible or visual feedback on a function of a component of an air hose system.

The audible feedback may be, for example, a sound that indicates whether an air hose is connected to and/or disconnected from an aircraft and/or a sound that indicates whether the supply of air from an air supply system has been started and/or stopped and/or a sound that indicates whether the air hose is being deployed from and/or returned to an air hose storage system.

The visual feedback may be, for example, a visual signal for example a light, e.g. a light emitting diode, that indicates whether an air hose is connected to and/or disconnected from an aircraft and/or a visual signal for example a light, e.g. a light emitting diode, that indicates whether the supply of air from an air supply system has been started and/or stopped and/or a visual signal for example a light, e.g. a light emitting diode, that indicates whether the air hose is being deployed from and/or returned to an air hose storage system.

It will also be appreciated by those skilled in the art that any number of combinations of the aforementioned features and/or those shown in the appended drawings provide clear advantages over the prior art and are therefore within the scope of the invention described herein.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

### REFERENCE NUMBERS

2 air hose
4 first of air hose
10 air hose connector
12 first end of air hose connector
14 second end of air hose connector
16 tubular body
18 outer wall
20 flange
22 seal
24 first aperture of flange
26 first opening of seal
28 second opening of seal
30 handle
32 grip portion of handle
34 locking member of handle
36 remote control unit
38 button
40 second handle
42 grip portion of second handle
44 locking member of second handle
46 outer housing
48 second outer housing
100 air hose connector
112 first end of air hose connector
114 second end of air hose connector
132 grip portion of handle
134 locking member of handle
136 remote control unit
138 button
140 second handle
142 grip portion of second handle
144 locking member of second handle
146 remote control unit
148 button

1. An air hose connector for an air hose, the air hose connector comprising:
a first end that is configured for direct or indirect connection to a pre-conditioned air hose,
a second open end that is configured for connection to an aircraft, and
a handle operably connected to the air hose connector;
wherein the handle comprises:
a grip portion adjacent to said first end of said connector, and
a locking member adjacent to said first end of said connector;
wherein said handle is configured to move the locking member between a first, locked, configuration and a second, unlocked, configuration; and
wherein the handle comprises a remote control unit that is configured to control a function of a component of an air hose system.

2. An air hose connector according to claim 1, wherein said grip portion includes said remote control unit.

3. An air hose connector according to claim 1, wherein said remote control unit is integrated into said grip portion.

4. An air hose connector according to claim 1, wherein said remote control unit includes a button or a pushbutton.

5. An air hose connector according to claim 4, wherein said button is wireless.

6. An air hose connector according to claim 4, wherein said button includes a transmitter.

7. An air hose connector according to claim 4, wherein said button is battery-less.

8. An air hose connector according to claim 7, wherein said button includes an energy converter.

9. An air hose connector according to claim 8, wherein the energy converter is an electric generator.

10. An air hose connector according to claim 1, wherein said handle is pivotably connected to said connector.

11. An air hose connector according to claim 10, wherein said handle is pivotably connected to an outer wall of said connector.

12. An air hose connector according to claim 1, wherein said connector comprises an outer housing within which a portion of the handle is accommodated.

13. An air hose connector according to claim 12, wherein said grip portion extends from a recess at a first end of said outer housing.

14. An air hose connector according to claim 13, wherein said locking member extends through a recess at a second end of said outer housing.

15. An air hose connector according to claim 1, wherein the component is an air hose storage system and the remote control unit is configured to control the movement of an air hose into and/or out of an air hose storage system.
